(19) United States
(12) Patent Application Publication
(10) Pub. No.: US 2004/0036904 A1
(43) Pub. Date: Feb. 26, 2004

(54) Image forming apparatus and method of activating a program

(76) Inventor: Hiroyuki Kimbara, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/457,349

(22) Filed: Jun. 10, 2003

(30) Foreign Application Priority Data
Jun. 11, 2002 (JP) 2002-170193
Jun. 9, 2003 (JP) 2003-164030

(51) Int. Cl. G06F 15/00; B41F 1/00

(52) U.S. Cl. 358/1.14; 358/1.13

(57) ABSTRACT

An image forming apparatus includes: hardware resources used in image forming processing; a program for executing image forming processing; a recording medium on which programs are recorded; a program selection part that presents one or more of the programs recorded on the recording medium to a user, and causes the user to select a program that the user desires to activate from the presented programs; and a program activation part that reads out the selected program from the recording medium and activates the selected program.

### BACKGROUND OF THE INVENTION

1. Field of the Invention

The present invention generally relates to image forming apparatuses and methods of activating a program, and more particularly to an image forming apparatus that has a platform between a hardware resource and a program and activates the program from a recording medium, and a method of activating the program.

2. Description of the Related Art

Recently, image forming apparatuses incorporating the functions of a printer, a copier, a facsimile machine, and a scanner in a single housing have become well-known. Hereinafter, such image forming apparatuses are referred to as multi-function apparatuses. The multi-function apparatus has a display part, a printing part, and an image acquisition part provided in a single housing, and includes different types of software corresponding to a printer, a copier, a facsimile machine, and a scanner. The multi-function apparatus operates as a printer, a copier, a facsimile machine, or a scanner by switching the software types.

When the multi-function apparatus is turned on, a BIOS (Basic Input/Output System) and a boot loader are activated. The boot loader loads a kernel and a root file system into a RAM (Random Access Memory), and activates the kernel, which then mounts the root file system. Here, the term “mount” refers to activating a file system or a peripheral device so that the file system or peripheral device is accessible.

After the activation of the kernel, an application/service activation program for activating applications and various services is activated. The application/service activation program, which is the first process to be activated in the multi-function apparatus, mounts a file system in accordance with a predetermined configuration file, and activates the processes of the service layer and applications required for the operation of the multi-function apparatus in accordance with a predetermined configuration file.

### SUMMARY OF THE INVENTION

The conventional multi-function apparatus records the programs of the applications to be activated and the configuration file corresponding to the applications to be activated on a hard disk drive (HDD). The application/service activation program activates the applications based on the corresponding configuration file prerecorded on the HDD. That is, the conventional multi-function apparatus requires the configuration file corresponding to the applications used by the users to be prerecorded on the HDD.

In the conventional multi-function apparatus, however, the number of applications that can be activated simultaneously is limited due to the problem of memory capacity. That is, in the conventional multi-function apparatus, it is necessary to prepare the configuration file in accordance with the number of applications that can be activated simultaneously and the applications used by the users, and prerecord the configuration file in the HDD.

As a result, the conventional multi-function apparatus has a problem in that all the activated applications are not necessarily required by the users. Further, since the conventional multi-function apparatus is limited in the number of applications that can be activated simultaneously, the conventional multi-function apparatus cannot provide many types of applications to the users.

Accordingly, it is a general object of the present invention to provide an image forming apparatus and a method of activating a program in which the above-described disadvantages are eliminated.

A more specific object of the present invention is to provide an image forming apparatus and a method of activating a program that can select a program to be activated from a recording medium.

The above objects of the present invention are achieved by an image forming apparatus including: hardware resources used in image forming processing; a program for executing image forming processing; a recording medium on which programs are recorded; a program selection part that presents one or more of the programs recorded on the recording medium to a user, and causes the user to select a program that the user desires to activate from the presented programs; and a program activation part that reads out the selected program from the recording medium and activates the selected program.

The above objects of the present invention are also achieved by a program activation method for an image forming apparatus including hardware resources used in image forming processing, a program for executing image forming processing, and a recording medium on which programs are recorded, the program activation method including the steps of: (a) presenting one or more of the programs recorded on the recording medium to a user, and causing the user to select a program that the user desires to activate from the recorded programs; and (b) reading the selected program from the recording medium, and activating the selected program.

According to the present invention, a user can select a program that the user desires to activate from one or more programs recorded on a recording medium. As a result, it is possible to activate a necessary program efficiently.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a multi-function apparatus according to an embodiment of the present invention;

FIG. 2 is a block diagram showing a hardware configuration of the multi-function apparatus according to the embodiment of the present invention;

FIG. 3 is a block diagram showing a configuration of a multi-function apparatus activation part of the multi-function apparatus according to the embodiment of the present invention;

FIG. 4 is a diagram showing a configuration of a file tree according to the embodiment of the present invention;

FIG. 5 is a diagram showing a configuration of a master configuration file according to the embodiment of the present invention;

FIG. 6 is a diagram showing a configuration of a configuration file according to the embodiment of the present invention;

FIG. 7 is a diagram showing a file tree of an HDD of the multi-function apparatus according to the embodiment of the present invention;

FIG. 8 is a diagram showing another file tree of the HDD of the multi-function apparatus according to the embodiment of the present invention;

FIG. 9 is a block diagram for illustrating one embodiment of a program activation method according to the embodiment of the present invention;

FIG. 10 is a flowchart of an operation according to the program activation method according to the embodiment of the present invention;

FIG. 11 is a flowchart of an application selection operation according to the embodiment of the present invention;

FIG. 12 is a diagram showing an option configuration file according to the embodiment of the present invention;

FIG. 13 is a diagram showing an application selection screen according to the embodiment of the present invention;

FIG. 14 is a flowchart of an application activation operation according to the embodiment of the present invention;

FIG. 15 is a diagram showing another application selection screen according to the embodiment of the present invention;

FIG. 16 is a diagram showing another application selection screen according to the embodiment of the present invention; and

FIG. 17 is a flowchart of another operation according to the program activation method according to the embodiment of the present invention.

### DETAILED DESCRIPTION OF THE PREFERRED EMBODIMENTS

A description is given below, with reference to the accompanying drawings, of an embodiment of the present invention.

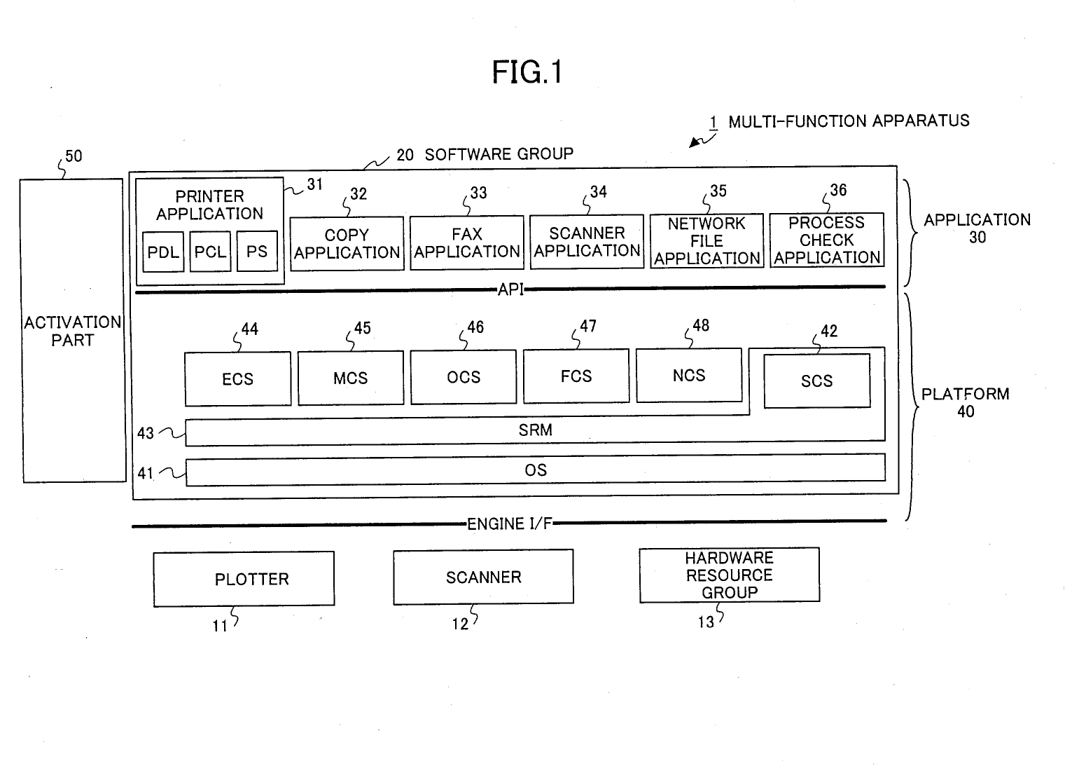

FIG. 1 is a block diagram showing a multi-function apparatus 1 according to the embodiment of the present invention. The multi-function apparatus 1 includes a plotter 11, a scanner 12, a hardware resource group 13 including hardware resources such as a facsimile machine, a software group 20, and a multi-function apparatus activation part 50. The hardware resources may also be referred to by the same reference numeral 13 as the hardware resource group. Further, the software group 20 includes an application 30 and a platform 40.

The application 30 performs operations characteristic of user services related to image forming operations of a printer, a copier, a facsimile machine, and a scanner.

The application 30 includes a printer application 31 for printing having page description languages such as PDL, PCL, and PostScript (PS), a copy application 32 for copying, a fax application 33 for facsimile, a scanner application 34 for scanning, a network file application 35 for network filing, and a process check application 36 for process checking.

The platform 40 includes a control service that interprets a processing request from the application 30 and generates a request to acquire a hardware resource accordingly, a system resource manager (SRM) 43 that manages more than one hardware resource and performs arbitration on the request from the control service, and an operating system (OS) 41.

The control service includes one or more service modules such as a system control service (SCS) 42, an engine control service (ECS) 44, a memory control service (MCS) 45, an operation panel control service (OCS) 46, a facsimile control service (FCS) 47, and a network control service (NCS) 48.

The platform 40 includes an application program interface (API) through which the processing request from the application 30 is made receivable by a predefined function. The OS 41, which may be UNIX®, executes software programs of the application 30 and the platform 40 in parallel as processes.

The process of the SRM 43 controls the system and manages the hardware resources in cooperation with the SCS 42. For instance, the process of the SRM 43 performs arbitration and execution control according to a request from a higher layer for the use of hardware resources such as an engine, a memory, an HDD file, and a host I/O (a Centronics I/F, a network I/F, an IEEE 1394 I/F, or RS-232-C I/F, for instance).

Specifically, the SRM 43 determines whether the requested hardware resources are available, that is, whether the requested hardware resources are being used by another request. If the requested hardware resources are available, the SRM 43 notifies the higher layer that the requested hardware resources are available. Further, in response to the request from the higher layer, the SRM 43 performs scheduling for using the hardware resources, and directly carries out the requested contents such as paper feeding and image formation by a printer engine, memory reservation, and file creation.

The SCS 42 performs processing such as application management, operation part control, system screen display, LED display, hardware resource management, and interrupting application control. The ECS 44 controls the engines of the plotter 11, the scanner 12, and the hardware resources 13.

The MCS 45 performs the memory control operations of acquiring and releasing image memory, using an HDD, and compressing and decompressing image data, for instance. The OCS 46 controls an operation panel that serves as an information transmission part between an operator and control of the main body of the multi-function apparatus 1.

The FCS 47 provides the API for transmitting and receiving facsimile communication from each application layer of a system controller using a PSTN or ISDN network, registering and citing a variety of facsimile data managed in a backup memory, reading facsimile communications, printing received facsimile communications, and performing multi-function-related transmission and reception.

The NCS 48 provides services that can be used in common among applications requiring network I/O. The NCS 48 mediates in distributing the data received from the network in accordance with each protocol among the applications and transmitting the data received from the applications to the network.

For instance, the NCS 48 controls data communication with the network devices connected through the network by HTTP (HyperText Transfer Protocol), using an HTTPd (HyperText Transfer Protocol Daemon).

The multi-function apparatus 1 can process all the operations required in common among the applications solely on the platform 40. Next, a description is given below of the hardware configuration of the multi-function apparatus 1.

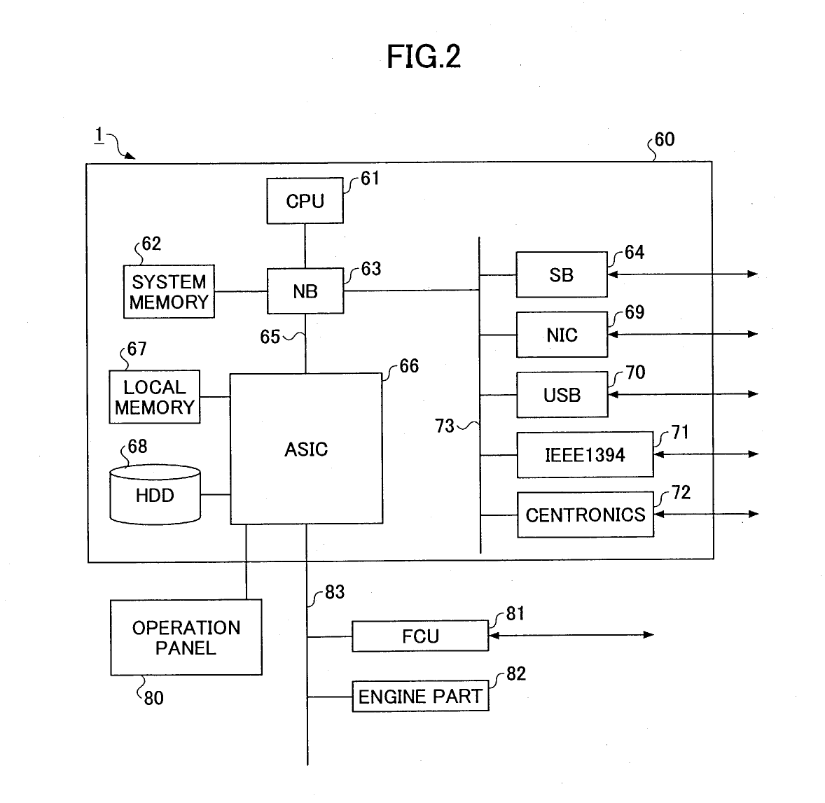

FIG. 2 is a block diagram showing a hardware configuration of the multi-function apparatus 1 according to this embodiment. The multi-function apparatus 1 includes a controller 60, an operation panel 80, a facsimile control unit (FCU) 81, and an engine part 82.

The controller 60 includes a CPU 61, a system memory 62, a Northbridge (NB) 63, a Southbridge (SB) 64, an ASIC (Application Specific Integrated Circuit) 66, a local memory 67, an HDD 68, a network interface card (NIC) 69, a USB device 70, an IEEE 1394 device 71, and a Centronics interface 72.

The operation panel 80 is connected to the ASIC 66 of the controller 60. The FCU 81 and the engine part 82 are connected to the ASIC 66 of the controller 60 via a PCI (Peripheral Component Interconnect) bus 83.

In the controller 60, the local memory 67 and the HDD 68 are connected to the ASIC 66, and the CPU 61 and the ASIC 66 are connected via the NB 63 of the CPU chipset. Thus, by connecting the CPU 61 and the ASIC 66 via the NB 63, the controller 60 can be used in the case where the interface of the CPU 61 is not open to the public. The ASIC 66 and the NB 63 are connected via an AGP (Accelerated Graphics Port) 65.

Thus, in order to control the execution of one or more processes forming the application 30 and the platform 40 of FIG. 1, the ASIC 66 and the NB 63 are connected not via a low-speed PCI bus but via the AGP 65, thereby preventing a decrease in the performance.

The CPU 61 controls the entire multi-function apparatus 1. The CPU 61 activates the SCS 42, the SRM 43, the ECS 44, the MCS 45, the OCS 46, the FCS 47, and the NCS 48 on the OS 41, and causes the OS 41 to execute them. The CPU 61 also activates the printer application 31, the copy application 32, the fax application 33, the scanner application 34, the network file application 35, and the process check application 36 of the application 30 on the OS 41, and causes the OS 41 to execute them.

NB 63 is a bridge for connecting the CPU 61, the system memory 62, the SB 64, the ASIC 66, the NIC 69, the USB device 70, the IEEE 1394 device 71, and the Centronics interface 72.

The SB 64, the NIC 69, the USB device 70, the IEEE 1394 device 71, and the Centronics interface 72 are connected to the NB 63 via a PCI bus 73. The SB 64 is a bridge for connecting the PCI bus 73 with a ROM and peripheral devices.

The system memory 62 may be employed as a memory for image drawings of the multi-function apparatus 1. The local memory 67 is employed as an image buffer for copying and a code buffer.

The ASIC 66 is an IC for image processing including a hardware element for image processing. The HDD 68 is a storage device (a secondary storage device) for storing image data, document data, programs, font data, and forms.

The NIC 69 is an interface device for connecting the multi-function apparatus 1 with a network. The USB device 70, the IEEE 1394 device 71, and the Centronics interface 72 are interfaces complying with their respective standards.

The operation panel 80 is an operation part for receiving the operations input from the operator and performing display for the operator. The FCU 81 includes a memory for backup use. For instance, the memory of the FCU 81 is used for temporarily storing the facsimile data received when the power of the multi-function apparatus 1 is off.

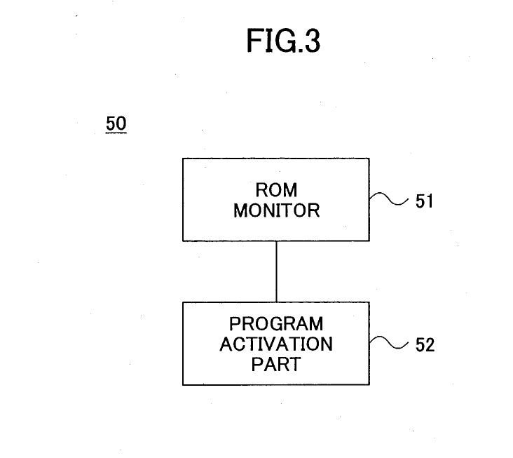

The multi-function apparatus activation part 50 of FIG. 1 is started first when the multi-function apparatus 1 is turned on, and activates the platform 40 and the application 30. FIG. 3 is a block diagram showing a configuration of the activation part 50. The activation part 50 includes a ROM monitor 51 and a program activation part 52.

The ROM monitor 51 as a BIOS and a boot loader is started when the multi-function apparatus 1 is turned on, and initializes the hardware and software and diagnoses the controller 60. The ROM monitor 51 loads a kernel and a root file system into the system memory 62, and activates the kernel. Then, the kernel mounts the root file system.

The program activation part 52 as an application/service activation program, which is called by the kernel, reserves memory regions on the system memory 62 and the local memory 67. The program activation part 52, which is the process of the multi-function apparatus 1 that is started first, mounts a file system according to a predetermined configuration file.

The program activation part 52 reads out the programs of the application 30 and the platform 40 which programs are required for an operation of the multi-function apparatus 1 from the HDD 68 or a ROM in accordance with a predetermined configuration file. Then, the program activation part 52 loads the read-out programs into the reserved memory regions of the system memory 62 and the local memory 67, and activates the processes of the application 30 and the platform 40.

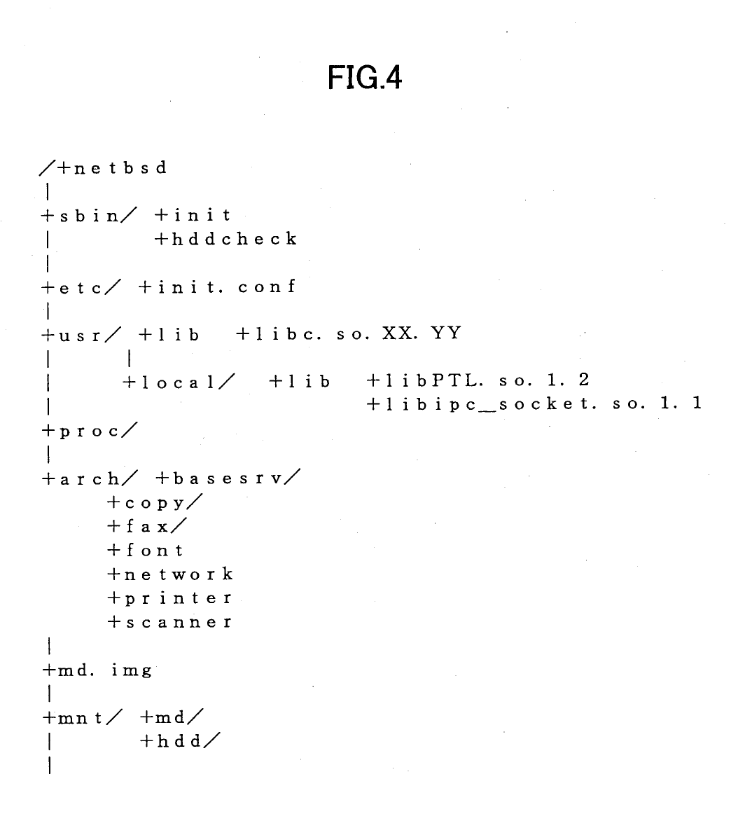

A description is given below of an operation of the program activation part 52. The program activation part 52 reads a predetermined master configuration file at the time of its activation, and mounts a file system and activates processes in accordance with the read master configuration file. FIG. 4 is a diagram showing a configuration of a file tree. In the case of the file tree of FIG. 4, for instance, the program activation part 52 reads “/etc/init.conf” as the master configuration file at the time of the activation.

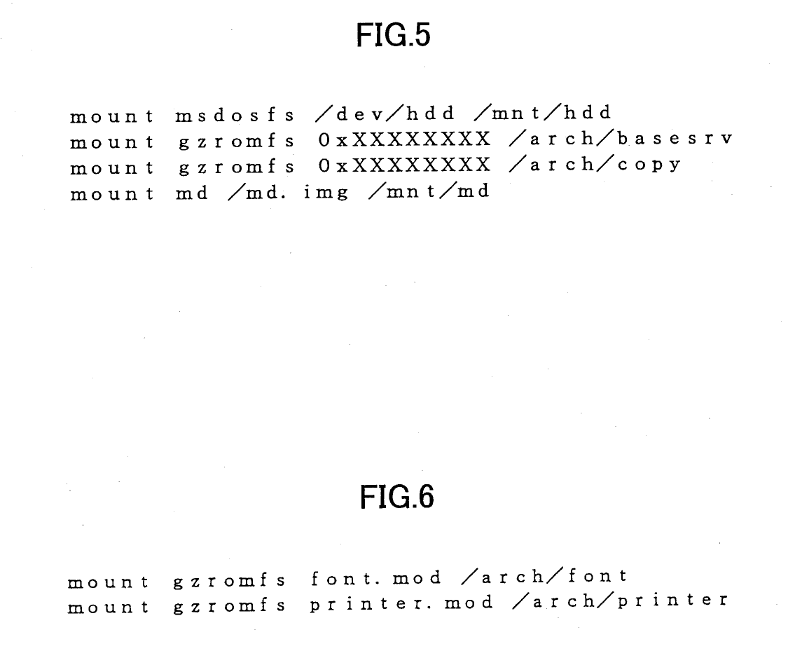

If a statement for mounting exists in the read master configuration file, the program activation part 52 performs mounting in accordance with the statement. FIG. 5 is a diagram showing a configuration of the master configuration file. In the case of the configuration of FIG. 5, for instance, the program activation part 52 mounts a file system on the HDD 68 in accordance with the statement for mounting.

Further, if a predetermined configuration file exists in the root of the mounted file system, or if a predetermined directory including a file of a predetermined extension exists in the root of the mounted file system, the program activation part 52 reads the predetermined configuration file or the file of the predetermined extension, and performs mounting.

FIG. 6 is a diagram showing a configuration of the configuration file. For instance, if a configuration file “init.conf” or “init.cnf” having the configuration of FIG. 6 exists in the root of the mounted file system on the HDD 68 (hereinafter referred to as an HDD file system), the program activation part 52 performs mounting in accordance with statements for mounting existing in the configuration file.

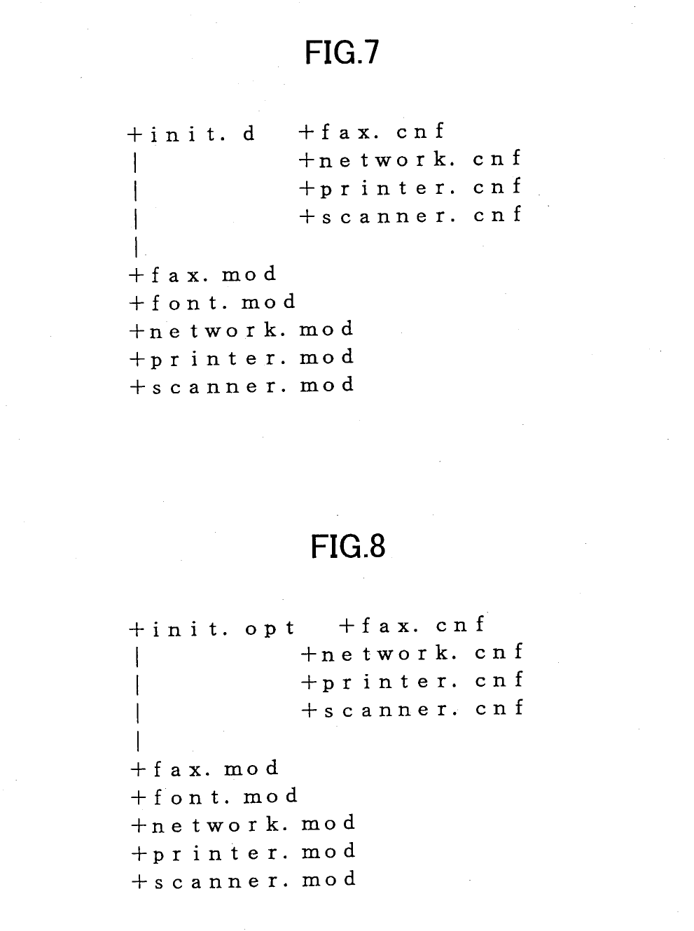

FIG. 7 is a diagram showing a file tree of the HDD 68. If a directory “init.d” as shown in FIG. 7 exists in the root of the mounted HDD file system and the directory includes a file of an extension of “conf” or “cnf,” the program activation part 52 performs mounting in accordance with a statement for mounting existing in the file.

FIG. 8 is a diagram showing another file tree of the HDD 68. If a directory “init.opt” as shown in FIG. 8 exists in the root of the mounted HDD file system, the program activation part 52 performs an operation relating to a program activation method according to the present invention.

The file systems that the program activation part 52 can mount include “gzromfs” shown in FIGS. 5 and 6. This file system “gzromfs” is mounted by loading a gzip-compressed ROMFS file into the system memory 62 and the local memory 67.

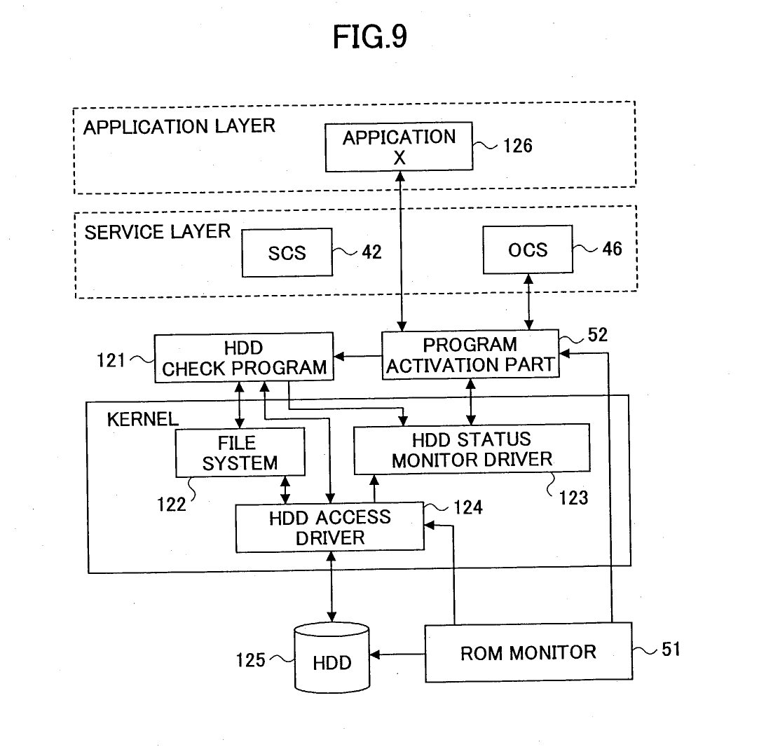

A description is given below of the case where the multi-function apparatus 1 activates an application recorded on the HDD 68. FIG. 9 is a block diagram for illustrating one embodiment of the program activation method according to the embodiment of the present invention. FIG. 9 shows only the configuration as necessary for the description and omits configuration parts unnecessary for the description.

Referring to FIG. 9, an HDD 125 records file systems, the programs of the service layer and the applications, and font data as binary files each composed of a header storing module information and ROMFS-formatted data. The HDD 125 starts spinning when the multi-function apparatus 1 is turned on.

When the multi-function apparatus 1 is turned on, the ROM monitor 51 checks the presence or absence of the connection with the HDD 125, and provides an HDD access driver 124 and the program activation part 52 with activation information such as the number of drives supported by the HDD 125. The HDD access driver 124 controls access to the HDD 125.

An HDD status monitor driver 123 manages the status information of the HDD 125, such as the mounting and unmounting of the HDD 125, and reports the status information of the HDD 125 to the program activation part 52.

The program activation part 52, after notifying the HDD status monitor driver 123 that the program activation part 52 is waiting for the HDD 125 to become readable, activates an HDD check program 121. When the program activation part 52 receives from the HDD status monitor driver 123 a notification that the HDD 125 is in a readable state, the program activation part 52 activates a process 126 of an application X recorded on the HDD 125 in accordance with the corresponding configuration file.

If the directory “init.opt” exists in the root of the file system of the HDD 125, the program activation part 52 performs an application selection operation. The application selection operation selects one or more of the applications recorded on the HDD 125 which the user desires to activate. For instance, the program activation part 52 displays a screen for application selection (an application selection screen) on the operation panel 80 via the OCS 46. The information on the application(s) selected by the user through the operation of the operation panel 80 is supplied via the OCS 46 to the program activation part 52.

The HDD check program 121 checks the correctness of the partitions of the HDD 125 and the state of a file system 122 of the HDD 125 so as to make the file system 122 usable. The HDD check program 121 reports the status information of the HDD 125 to the HDD status monitor driver 123.

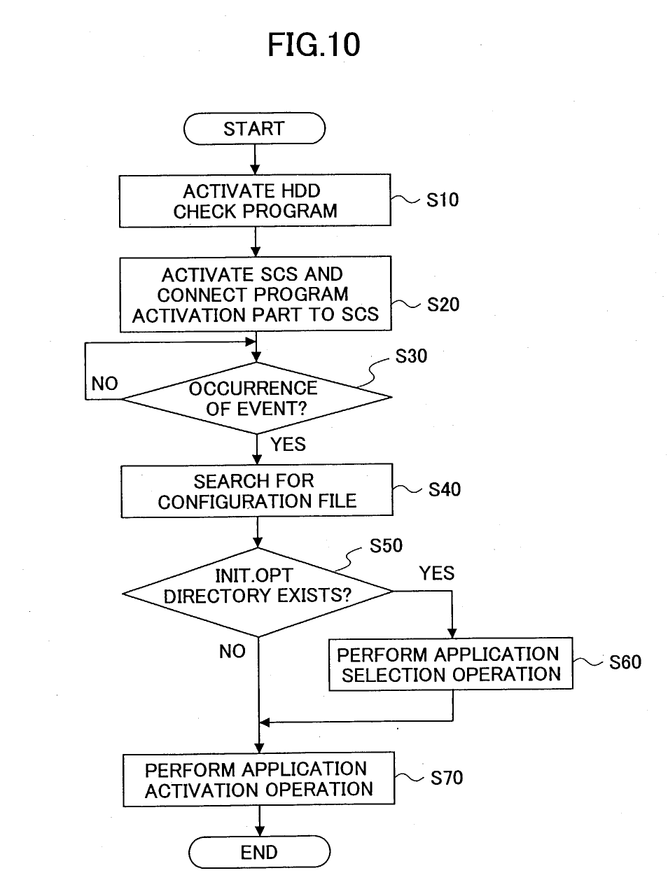

Next, a description is given below, with reference to FIGS. 10 through 14, of an operating procedure according to the program activation method of the present invention. When the multi-function apparatus 1 is turned on, the program activation part 52 is activated as the first process of the multi-function apparatus 1. FIG. 10 is a flowchart of an operation according to the program activation method of the present invention.

In step S10 of FIG. 10, the program activation part 52 activates the HDD check program 121. Next, in step S20, the program activation part 52 activates the SCS 42, and gets connected thereto. Then, utilizing the SCS 42, the program activation part 52 prepares to use the OCS 46.

In step S30, the program activation part 52 determines the presence or absence of the occurrence of an event. If the program activation part 52 determines in step S30 that there is no occurrence of an event (that is, “NO” in step S30), the program activation part 52 repeats the operation of step S30. The program activation part 52 may remain switched to a wait state from an executing state until an event occurs. If the program activation part 52 determines in step S30 that there is the occurrence of an event (that is, “YES” in step S30), the program activation part 52 proceeds to perform step S40. For instance, the program activation part 52 determines that there is the occurrence of an event when the HDD status monitor driver 123 notifies the program activation part 52 that the HDD 125 is in a readable state.

In step S40, the program activation part 52 searches for a (normal) configuration file. Next, in step S50, the program activation part 52 determines whether the directory of “init.opt” exists in the root of the HDD 125.

If the program activation part 52 determines that the directory of “init.opt” exists in the root of the HDD 125 (that is, “YES” in step S50), the program activation part 52 proceeds to perform step S60. If the program activation part 52 determines that the directory of “init.opt” does not exist in the root of the HDD 125 (that is, “NO” in step S50), the program activation part 52 proceeds to perform step S70.

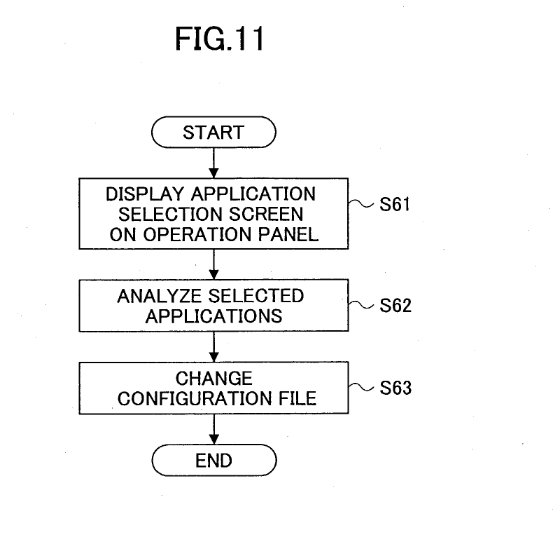

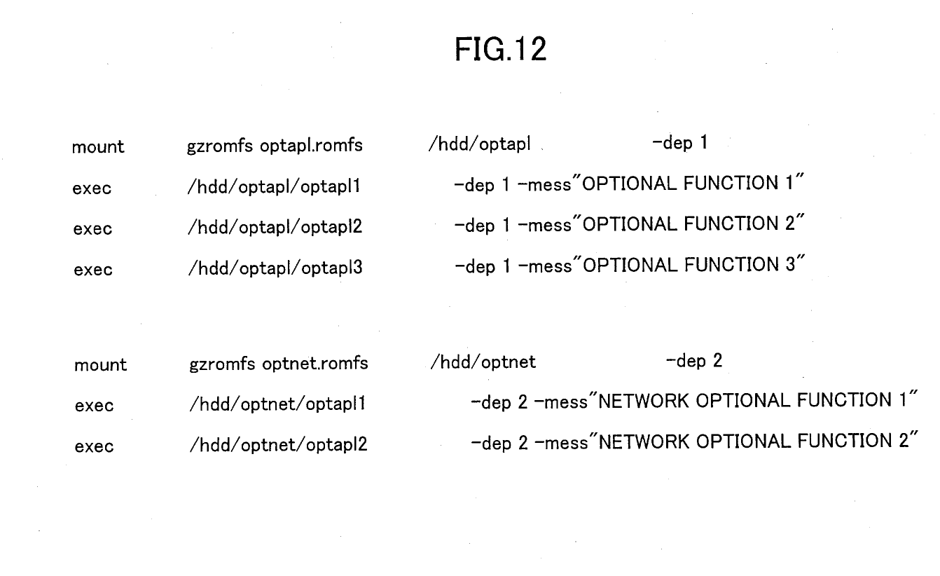

FIG. 11 is a flowchart of an application selection operation according to the embodiment of the present invention. In step S60 of FIG. 10, the program activation part 52 performs an application selection operation as shown in FIG. 11. In step S61 of FIG. 11, the program activation part 52 analyzes a configuration file stored in the directory of “init.opt” as shown in FIG. 12. The configuration file stored in the directory of “init.opt” is referred to as an option configuration file, which is a configuration file for activating an application selectable by the user.

FIG. 12 is a diagram showing an option configuration file according to the embodiment of the present invention. In the configuration file, “-dep” represents the dependency relation of each line of statement written therein. That is, the lines having the same “-dep” number form a group in the option configuration file. For instance, in the option configuration file of FIG. 12, the first through fourth lines form a group, and the fifth through seventh lines form another group.

The option configuration file indicates that when any of the commands of the second and following lines of a group is executed, the command of the first line is executed.

In the case of the option configuration file of FIG. 12, for instance, when any of the commands “exec” of the second through fourth lines having “-dep” number 1 is executed, the command “mount” of the first line having the same “-dep” number 1 is executed.

Further, a command “-mess” written in the option configuration file represents a character string to be displayed on the application selection screen. In the case of FIG. 12, for instance, “Optional Function 1, Optional Function 2, Optional Function 3, Network Optional Function 1, and Network Optional Function 2” are set as the character strings to be displayed on the application selection screen.

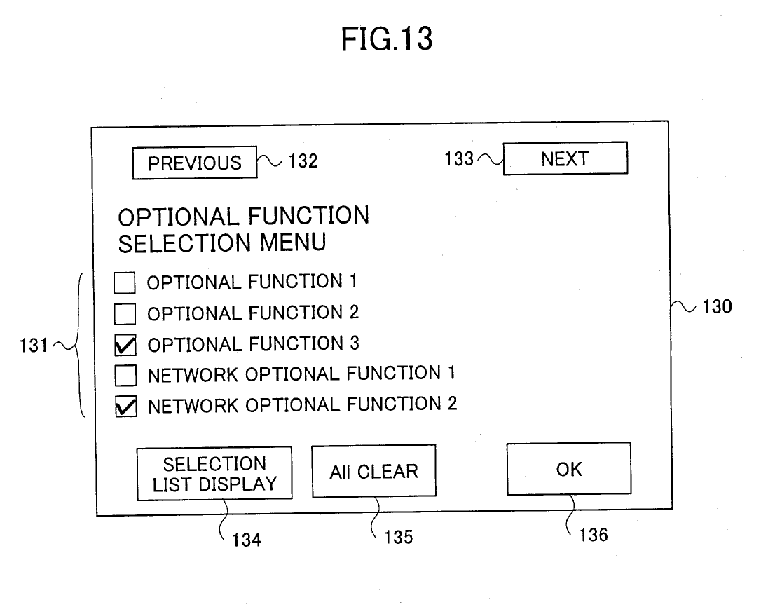

The program activation part 52, based on the results of analyzing the option configuration file, displays an application selection screen 130 as shown in FIG. 13 on the operation panel 80. Specifically, the program activation part 52 displays the application selection screen 130 on the operation panel 80, utilizing the OCS 46.

FIG. 13 is a diagram showing an image of the application selection screen 130. The application selection screen 130 of FIG. 13 displays the names of the functions (or applications) selectable by the user. An input box 131 provided in front of the name of each function represents the presence or absence of selection. If the names of the selectable functions are displayed over a plurality of pages, the user can move back to the previous page or move on to the next page from the current page by pressing a PREVIOUS-page button 132 or a NEXT-page button 133.

A SELECTION LIST DISPLAY button 134 is pressed to display the names of the functions selected by the user. An ALL CLEAR button 135 is pressed to clear all of the functions selected by the user. An OK button 136 is pressed to confirm the functions selected by the user.

The OCS 46 reports the ID of the button pressed by the user to the program activation part 52. If the reported ID of the button pressed by the user represents any of the buttons other than the OK button 136, the program activation part 52 changes the application selection screen 130 displayed on the operation panel 80 according to the pressed button.

If the reported ID of the button pressed by the user represents the OK button 136, the program activation part 52 proceeds to perform step S62. In step S62, the program activation part 52 analyzes the selected functions and the functions having dependency relation thereto. In the case of the option configuration file of FIG. 12, for instance, when Optional Function 3 is selected on the application selection screen 130, the command “exec” of the fourth line and the command “mount” of the first line included in the same group are selected as the selected function and the function having dependency relation thereto.

Next, in step S63, the program activation part 52 changes the configuration file according to the results of the analysis of step S62. For instance, the program activation part 52 deletes the unselected functions and the functions having no dependency relation to the selected functions, and creates a normal configuration file as stored in the directory “init.d”.

In this case (see FIG. 13), the second and third commands “exec” and the sixth command “exec” are deleted from the option configuration file of FIG. 12 as unselected functions.

The operation of step S60 of FIG. 10 causes the user to select from the selectable functions a function that the user desires to activate, and creates a configuration file for the selected function.

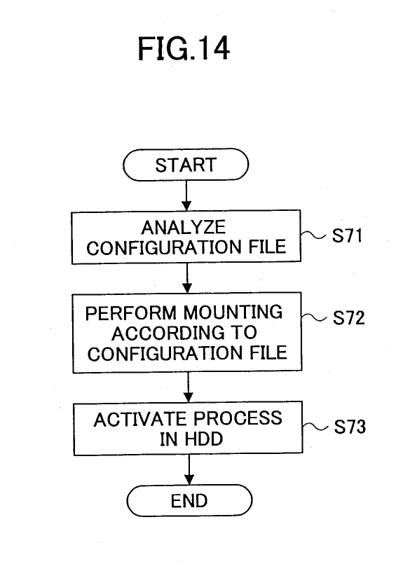

Next, in step S70, the program activation part 52 performs an application activation operation as shown in FIG. 14. FIG. 14 is a flowchart of an application activation operation according to the embodiment of the present invention. In step S71 of FIG. 14, the program activation part 52 analyzes a normal configuration file. The normal configuration file analyzed in step S71 differs depending on whether the directory “init.opt” exists in the root of the HDD 125.

If the directory “init.opt” exists in the root of the HDD 125, the program activation part 52 analyzes the normal configuration file created in step S63. On the other hand, if the directory “init.opt” does not exist in the root of the HDD 125, the program activation part 52 analyzes the normal configuration file searched out in step S40.

Next, in step S72, the program activation part 52 performs mounting in accordance with the statement of “mount” existing in the configuration file. Then, in step S73, the program activation part 52 activates the process of a function (or an application) recorded on the HDD 125 in accordance with the contents of the configuration file.

The operation of step S60 may be performed as follows. In step S61 of FIG. 11, the program activation part 52 analyzes the option configuration file stored in the directory “init.opt” as shown in FIG. 12.

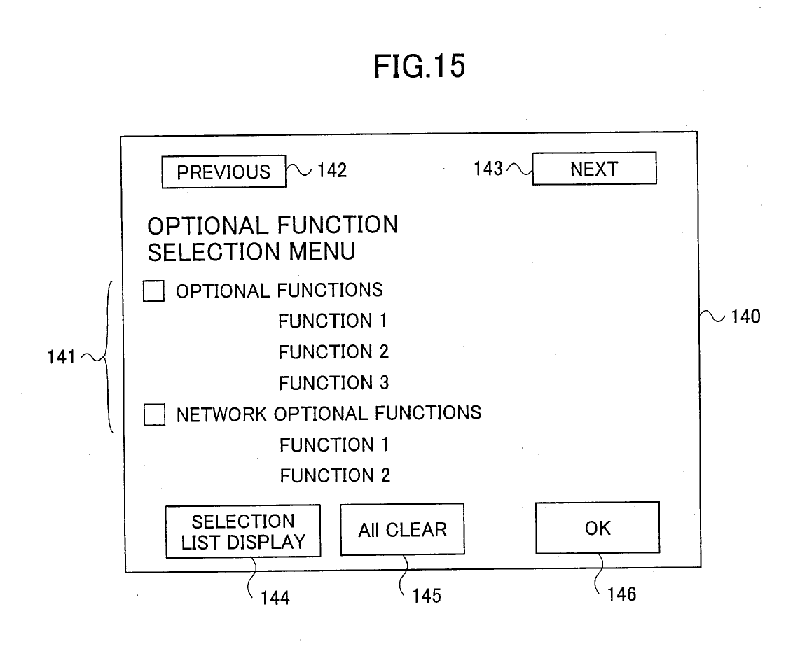

Then, based on the results of the analysis, the program activation part 52 displays an application selection screen 140 on the operation panel 80. FIG. 15 is a diagram showing the application selection screen 140. Specifically, the program activation part 52, utilizing the OCS 46, displays the application selection screen 140 on the operation panel 80.

The application selection screen 140 displays the names of the functions selectable by the user and the names of the groups including the functions. Specifically, the application selection screen 140 displays Functions 1 through 3 included in the group of Optional Functions and Functions 1 and 2 included in the group of Network Optional Functions.

An input box 141 provided in front of the name of each group represents the presence or absence of the selection of all the functions included in the group. A PREVIOUS page button 142, a NEXT page button 143, a SELECTION LIST DISPLAY button 144, an ALL CLEAR button 145, and an OK button 146 provided on the application selection screen 140 have the same functions as the buttons having the same names of the application selection screen 130 of FIG. 13, and therefore, a description thereof is omitted.

In the application selection screen 140 of FIG. 15, the functions are selected in a group of Functions 1 through 3 of Optional Functions or a group of Functions 1 and 2 of Network Optional Functions. That is, the dependency relationship of Functions 1 through 3 of Optional Functions or Functions 1 and 2 of Network Optional Functions is set by providing the same “-dep” number thereto in the option configuration file.

The OCS 46 reports the ID of the button pressed by the user to the program activation part 52. If the reported ID of the button pressed by the user represents any of the buttons other than the OK button 146, the program activation part 52 changes the application selection screen 140 displayed on the operation panel 80 according to the pressed button.

If the reported ID of the button pressed by the user represents the OK button 146, the program activation part 52 proceeds to perform step S62. In step S62, the program activation part 52 analyzes the selected functions and the functions having dependency relation thereto.

Next, in step S63, the program activation part 52 changes the configuration file according to the results of the analysis of step S62. For instance, the program activation part 52 deletes the unselected functions and the functions having no dependency relationship with the selected functions, and creates a normal configuration file as stored in the directory “init.d”.

In the case of using the application selection screen 140 of FIG. 15, the operation of step S60 of FIG. 10 causes the user to select a group including a function that the user desires to activate from the groups including the functions selectable by the user, and creates a configuration file for activating all the functions included in the group selected by the user. Then, the operation proceeds to step S70.

The operation of step S60 may also be performed as follows. In step S61 of FIG. 11, the program activation part 52 analyzes the option configuration file stored in the directory “init.opt” as shown in FIG. 12.

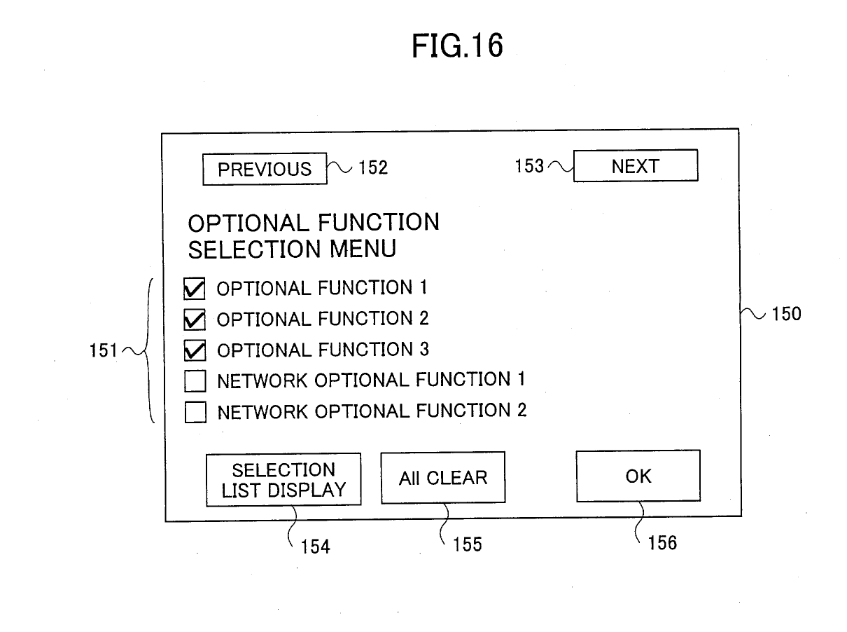

Then, based on the results of the analysis, the program activation part 52 displays an application selection screen 150 on the operation panel 80. FIG. 16 is a diagram showing the application selection screen 150. Specifically, the program activation part 52, utilizing the OCS 46, displays the application selection screen 150 on the operation panel 80.

The application selection screen 150 displays the names of the functions selectable by the user. An input box 151 provided in front of the name of each function indicates the presence or absence of selection.

A PREVIOUS page button 152, a NEXT page button 153, a SELECTION LIST DISPLAY button 154, an ALL CLEAR button 155, and an OK button 156 provided on the application selection screen 150 have the same functions as the buttons having the same names of the application selection screen 130 of FIG. 13, and therefore, a description thereof is omitted.

In the case of the option configuration file of FIG. 12, when Optional Function 1 is selected on the application selection screen 150 of FIG. 16, Optional Function 2 and Optional Function 3 are automatically selected as the functions having a dependency relationship with Optional Function 1.

That is, on the application selection screen 150 of FIG. 16, when a function is selected by the user, the functions provided with the same “-dep” number as the selected function are automatically selected.

The OCS 46 reports the ID of the button pressed by the user to the program activation part 52. If the reported ID of the button pressed by the user represents any of the buttons other than the OK button 156, the program activation part 52 changes the application selection screen 150 displayed on the operation panel 80 according to the pressed button.

If the reported ID of the button pressed by the user represents the OK button 156, the program activation part 52 proceeds to perform step S62. In step S62, the program activation part 52 analyzes the selected function and the functions having dependency relation thereto.

Next, in step S63, the program activation part 52 changes the configuration file according to the results of the analysis of step S62. For instance, the program activation part 52 deletes the unselected functions and the functions having no dependency relation to the selected function, and creates a normal configuration file as stored in the directory “init.d”.

In the case of using the application selection screen 150, the operation of step S60 of FIG. 10 creates a configuration file for activating the function selected by the user and the functions automatically selected by the selected function. Then, the operation proceeds to step S70.

The application selection screens 140 and 150 of FIGS. 15 and 16, respectively, are examples of the application selection screen according to the present invention for allowing the user to confirm the dependency relationship between functions on the operation panel 80. However, any application selection screen will do if the application selection screen allows the user to visually confirm the dependency relationship between functions on the operation panel 80.

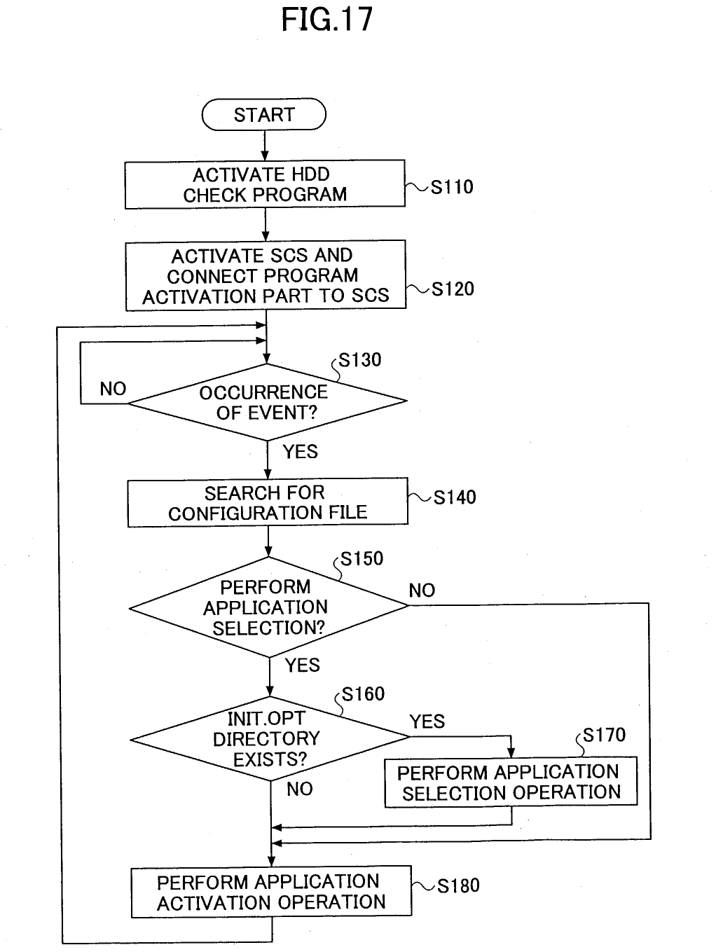

Further, a description is given below, with reference to the flowchart of FIG. 17, of another operation procedure according to the program activation method of the present invention. When the multi-function apparatus 1 is turned on, the program activation part 52 is activated as the first process of the multi-function apparatus 1. FIG. 17 is a flowchart of another operation according to the program activation method of the present invention.

The operations of steps S110 and S120 of FIG. 17 are equal to those of steps S10 and S20, respectively, of FIG. 10, and therefore, a description thereof is omitted. Next, in step S130, the program activation part 52 determines the presence or absence of the occurrence of an event. If the program activation part 52 determines in step S130 that there is no occurrence of an event (that is, “NO” in step S130), the program activation part 52 repeats the operation of step S130. The program activation part 52 may remain switched to a wait state from an executing state until an event occurs.

If the program activation part 52 determines in step S130 that there is the occurrence of an event (that is, “YES” in step S130), the program activation part 52 proceeds to perform step S140. For instance, the program activation part 52 determines that there is the occurrence of an event when the HDD status monitor driver 123 notifies the program activation part 52 that the HDD 125 is in a readable state or that the insertion of an SD card is detected. The following description is given of the case where the HDD status monitor driver 123 notifies the program activation part 52 that the HDD 125 is in a readable state.

In step S140, the program activation part 52 searches the HDD 125, which has caused an event to occur, for a configuration file. Next, in step S150, the program activation part 52 determines whether to perform application selection. The determination as to whether to perform application selection may be made by the user on the operation panel 80 or by the information as to whether to perform application selection set in the HDD 125. If the program activation part 52 determines to perform application selection (that is, “YES” in step S150), the program activation part 52 proceeds to step S160. If the program activation part 52 determines not to perform application selection (that is, “NO” in step S150), the program activation part 52 proceeds to step S180.

In step S160, the program activation part 52 determines whether an optional program exists in the HDD 125 by determining whether the directory “init.opt” exists in the root of the HDD 125.

If the program activation part 52 determines that the directory “init.opt” exists in the root of the HDD 125 (that is, “YES” in step S160), the program activation part 52 proceeds to step S170. If the program activation part 52 determines that the directory “init.opt” does not exist in the root of the HDD 125 (that is, “NO” in step S160), the program activation part 52 proceeds to step S180.

Since the operation of step S170 is equal to that of step S60 of FIG. 10, a description thereof is omitted.

In step S180, the program activation part 52 performs the application activation operation as described with reference to FIG. 14. When completing the operation of step S180, the program activation part 52 returns to step S130, and waits for an event to occur.

Next, a description is given of the case where the program activation part 52 determines in step S130 that there is the occurrence of an event based on the supplied notification that the insertion of an SD card is detected. When the program activation part 52 determines that there is the occurrence of an event (that is, “YES” in step S130), the program activation part 52 proceeds to step S140.

In step S140, the program activation part 52 searches the SD card, which has caused an event to occur, for a configuration file. Next, in step S150, the program activation part 52 determines whether to perform application selection.

The determination as to whether to perform application selection may be made by the user on the operation panel 80 or by the information as to whether to perform application selection set in the SD card. If the program activation part 52 determines to perform application selection (that is, “YES” in step S150), the program activation part 52 proceeds to step S160. If the program activation part 52 determines not to perform application selection (that is, “NO” in step S150), the program activation part 52 proceeds to step S180.

In step S160, the program activation part 52 determines whether the directory “init.opt” exists in the root of the SD card. That is, the program activation part 52 determines whether an optional program exists in the SD card by determining whether the directory “init.opt” exists in the root of the SD card.

If the program activation part 52 determines that the directory “init.opt” exists in the root of the SD card (that is, “YES” in step S160), the program activation part 52 proceeds to step S170. If the program activation part 52 determines that the directory “init.opt” does not exist in the root of the SD card (that is, “NO” in step S160), the program activation part 52 proceeds to step S180. Since the operations of steps S170 and S180 are equal to those of steps S60 and S70, respectively, of FIG. 10, a description thereof is omitted.

In the above-described embodiment, the operations according to the program activation method of the present invention are performed immediately after the multi-function apparatus 1 is turned on. However, the user may freely call the application selection screen 130, 140, or 150 and dynamically activate a function or application. For instance, the program activation part 52 displays the application selection screen 130, 140, or 150 on the operation panel 80 when the user operates the operation panel 80 to request the activation of a program.

In such a case, steps S30 through S70 of FIG. 10 or steps S130 through S180 of FIG. 17 are used. For instance, in step S30, the program activation part 52 may determine that there is the occurrence of an event when the user requests the program activation part 52 to activate a program.

By using the above-described program activation method according to the present invention, a large number of programs are recordable on the HDD 125 (or 68), and the user may select one or more of the programs which the user desires to activate. As a result, the program(s) required by the user can be activated with efficiency. Accordingly, a variety of programs may be provided to the user without an increase in the memory capacity of the multi-function apparatus 1.

The present invention is not limited to the specifically disclosed embodiment, but variations and modifications may be made without departing from the scope of the present invention.

The present application is based on Japanese priority application No. 2002-170193, filed on Jun. 11, 2002, the entire contents of which are hereby incorporated by reference.

What is claimed is:

1. An image forming apparatus comprising:
hardware resources used in image forming processing;
a program for executing image forming processing;
a recording medium on which programs are recorded;
a program selection part that presents one or more of the programs recorded on the recording medium to a user, and causes the user to select a program that the user desires to activate from the presented programs; and
a program activation part that reads out the selected program from the recording medium and activates the selected program.

2. The image forming apparatus as claimed in claim 1, wherein said program selection part, at a time of activating the image forming apparatus, presents the one or more of the programs recorded on the recording medium to the user, and causes the user to select the program that the user desires to activate from the presented programs.

3. The image forming apparatus as claimed in claim 2, wherein said program selection part, after receiving a notification that the recording medium has been normally activated, presents the one or more of the programs recorded on the recording medium to the user, and causes the user to select the program that the user desires to activate from the presented programs

4. The image forming apparatus as claimed in claim 3, wherein the recording medium is a hard disk drive.

5. The image forming apparatus as claimed in claim 1, wherein said program selection part, at a request of the user, presents the one or more of the programs recorded on the recording medium to the user, and causes the user to select the program that the user desires to activate from the presented programs.

6. The image forming apparatus as claimed in claim 1, wherein said program selection part, at a time of detecting insertion of the recording medium, presents the one or more of the programs recorded on the recording medium to the user, and causes the user to select the program that the user desires to activate from the presented programs.

7. The image forming apparatus as claimed in claim 1, wherein said program selection part displays the one or more of the programs recorded on the recording medium on an operation panel, and causes the user to select the program that the user desires to activate from the displayed programs through the operation panel.

8. The image forming apparatus as claimed in claim 7, wherein said program selection part displays the one or more of the programs recorded on the recording medium and one or more dependency relationships of the one or more of the programs on the operation panel.

9. The image forming apparatus as claimed in claim 8, wherein said program selection part causes the user to select, on the operation panel, the program that the user desires to activate in a group of one or more programs having equal dependency relationships.

10. The image forming apparatus as claimed in claim 7, wherein said program selection part, when the program that the user desires to activate is selected on the operation panel, additionally selects a program having a dependency relationship with the selected program.

11. The image forming apparatus as claimed in claim 1, further comprising an operation selection part that searches for a configuration file relating to program activation, and determines whether to perform the operation of said program selection part based on a result of the search for the configuration file.

12. The image forming apparatus as claimed in claim 11, wherein said program selection part changes the configuration file according to the program selected from the presented programs by the user.

13. The image forming apparatus as claimed in claim 12, wherein said program activation part reads out the selected program from the recording medium and activates the selected program in accordance with the configuration file.

14. The image forming apparatus as claimed in claim 13, wherein said operation selection part determines to perform the operation of said program selection part when the searched-out configuration file is an option configuration file, and determines not to perform the operation of said program selection part when the searched-out configuration file is a normal configuration file.

15. The image forming apparatus as claimed in claim 14, wherein the option configuration file and the normal configuration file are distinguished by at least one of a directory name, a file name, and an extension.

16. The image forming apparatus as claimed in claim 1, wherein said program selection part determines whether to perform the operation thereof based on a request of the user.

17. The image forming apparatus as claimed in claim 1, wherein said program selection part, after receiving a notification that insertion of the recording medium is detected, presents the one or more of the programs recorded on the recording medium to the user, and causes the user to select the program that the user desires to activate from the presented programs.

18. The image forming apparatus as claimed in claim 17, wherein the recording medium is hot-pluggable.

19. A program activation method for an image forming apparatus including hardware resources used in image forming processing, a program for executing image forming processing, and a recording medium on which programs are recorded, the program activation method comprising the steps of:
(a) presenting one or more of the programs recorded on the recording medium to a user, and causing the user to select a program that the user desires to activate from the recorded programs; and
(b) reading the selected program from the recording medium, and activating the selected program.

20. The program activation method as claimed in claim 19, wherein said step (a) is performed at a time of activating the image forming apparatus.

21. The program activation method as claimed in claim 20, wherein said step (a) is performed after receiving a notification that the recording medium has been normally activated.

22. The program activation method as claimed in claim 21, wherein the recording medium is a hard drive unit.

23. The program activation method as claimed in claim 19, wherein said step (a) is performed at a request of the user.

24. The program activation method as claimed in claim 19, wherein said step (a) is performed at a time of detecting insertion of the recording medium.

25. The program activation method as claimed in claim 19, wherein said step (a) displays the one or more of the programs recorded on the recording medium on an operation panel, and causes the user to select the program that the user desires to activate from the displayed programs through the operation panel.

26. The program activation method as claimed in claim 25, wherein said step (a) displays the one or more of the programs recorded on the recording medium and one or more dependency relationships of the one or more of the programs on the operation panel.

27. The program activation method as claimed in claim 26, wherein said step (a) causes the user to select, on the operation panel, the program that the user desires to activate in a group of one or more programs having equal dependency relationships.

28. The program activation method as claimed in claim 25, wherein said step (a), when the program that the user desires to activate is selected on the operation panel, additionally selects a program having a dependency relationship with the selected program.

29. The program activation method as claimed in claim 19, further comprising the step of (c) searching for a configuration file relating to program activation, and determining whether to perform said step (a) based on a result of the search for the configuration file.

30. The program activation method as claimed in claim 29, wherein said step (a) changes the configuration file according to the program selected from the presented programs by the user.

31. The program activation method as claimed in 30, wherein said step (b) reads out the selected program from the recording medium and activates the selected program in accordance with the configuration file.

32. The program activation method as claimed in claim 31, wherein said step (c) determines to perform said step (a) when the searched-out configuration file is an option configuration file, and determines not to perform said step (a) when the searched-out configuration file is a normal configuration file.

33. The program activation method as claimed in claim 32, wherein the option configuration file and the normal configuration file are distinguished by at least one of a directory name, a file name, and an extension.

34. The program activation method as claimed in claim 19, wherein it is determined based on a request of the user whether to perform said step (a).

35. The program activation method as claimed in claim 19, wherein said step (a) is performed after receiving a notification that insertion of the recording medium is detected.

36. The program activation method as claimed in claim 35, wherein the recording medium is hot-pluggable.
